(19) United States
(12) Patent Application Publication
(10) Pub. No.: US 2010/0070911 A1
(43) Pub. Date: Mar. 18, 2010

(54) Method And Apparatus For Implementing Three-Dimensional Panel At IM Client

(75) Inventor: Ziwei Huang, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/621,596

(22) Filed: Nov. 19, 2009

Related U.S. Application Data
(63) Continuation of application No. PCT/CN2008/070643, filed on Mar. 31, 2008.

(30) Foreign Application Priority Data
Jun. 19, 2007 (CN) 200710108490.7

(51) Int. Cl. G06F 3/048

(52) U.S. Cl. 715/782

(57) ABSTRACT

Embodiments of the present invention disclose a method and apparatus for implementing a three-dimensional panel at an IM client. The method includes: receiving request information of entering a three-dimensional panel; obtaining configuration information of the three-dimensional panel; obtaining identity information of IM contacts; and starting the three-dimensional panel according to the configuration information and displaying the identity information of the IM contacts on the three-dimensional panel. By the technical solutions provided by the present invention, the IM contacts of an IM user can be displayed on the three-dimensional panel, so that the IM user can communicate with the IM contacts in a three-dimensional scene, thereby solving the problem that the conventional panel is single and short of originality, and bringing better user experiences for the IM user.

### CROSS-REFERENCE TO RELATED APPLICATIONS

This application is a continuation of International Application No. PCT/CN2008/070643 filed on Mar. 31, 2008. This application claims the benefit and priority of Chinese Application No. 200710108490.7, filed Jun. 19, 2007. The entire disclosures of each of the above applications are incorporated herein by reference.

### FIELD

The present disclosure relates to Internet technologies, and more particularly, to a method and apparatus for implementing a three-dimensional panel at an IM client.

### BACKGROUND

This section provides background information related to the present disclosure which is not necessarily prior art.

Along with the rapid development of Internet, the number of netizens is gradually increased. Instant Messaging (IM) software is popularized with higher popularization rate in the netizens, and more and more netizens perform online communication by using the IM software. Through IM software, users can communicate with familiar or unknown people anywhere and anytime.

After a user logs on an IM client, a panel, i.e. a main interface of the IM client, is displayed. The panel is used to display IM contacts of the user. The panel usually displays identity information of users, e.g. name information used by the IM contacts, and pictures selected by the IM contacts. In addition, the panel may also display entrances of various operations in a menu mode, a button mode and so on.

Usually, an IM user has a certain number of IM contacts. In order to be convenient for the IM user to manage and search the IM contacts, the panel may display the IM contacts in a flat tree directory mode. Specifically, the names of the IM contacts are listed on the panel in a tree directory mode. Of course, the pictures selected by the IM contacts may also be displayed, so that the IM user can identify the IM contacts.

All conventional IM software displays the IM contacts in a flat interface tree list, which makes the panel design of the IM software single and short of originality, and can not bring better user experiences for IM user.

### SUMMARY

This section provides a general summary of the disclosure, and is not a comprehensive disclosure of its full scope or all of its features.

Embodiments of the present invention provide a method and apparatus for implementing a three-dimensional panel at an IM client. By using the technical solutions provided by the embodiments of the present invention, a three-dimensional panel can be implemented at the IM client.

A method for implementing a three-dimensional panel at an IM client includes:

receiving request information of entering a three-dimensional panel;

obtaining configuration information of the three-dimensional panel;

obtaining identity information of IM contacts; and

starting the three-dimensional panel according to the configuration information and displaying the identity information of the IM contacts on the three-dimensional panel.

An apparatus for implementing a three-dimensional panel at an IM client includes:

a request information receiving module, adapted to receive request information of entering a three-dimensional panel;

a configuration information obtaining module, adapted to obtain configuration information of the three-dimensional panel after the request information receiving module receives the request information;

an identity information obtaining module, adapted to obtain identity information of IM contacts after the request information receiving module receives the request information; and

a three-dimensional panel starting module, adapted to start the three-dimensional panel according to the configuration information and display the identity information of the IM contacts on the three-dimensional panel.

The embodiments of the present invention also provide a computer program product for implementing a three-dimensional panel at an IM client and a computer readable medium. The computer program product includes: a computer program code, adapted to execute the steps in the above-mentioned method when being run, and implement one or more modules in the above-mentioned apparatus.

It can be seen from the above mentioned, the three-dimensional panel can be implemented at the IM client by using the technical solutions provided by the embodiments of the present invention, and the IM contacts of the IM user can be displayed on the three-dimensional panel, so that the IM user can communicate with the IM contacts in a three-dimensional scene, thereby solving the problem that the conventional panel is single and short of originality and bringing better user experiences for the IM user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for implementing a three-dimensional panel at an IM client in accordance with a first embodiment of the present invention.

FIG. 2 is a schematic diagram illustrating a three-dimensional panel in accordance with an embodiment of the present invention.

FIG. 3 is a flowchart illustrating a method for implementing a three-dimensional panel at an IM client in accordance with a second embodiment of the present invention.

FIG. 4 is a flowchart illustrating a method for implementing a three-dimensional panel at an IM client in accordance with a third embodiment of the present invention.

FIG. 5 is a schematic diagram illustrating an apparatus for implementing a three-dimensional panel at an IM client in accordance with a fourth embodiment of the present invention.

FIG. 6 is a schematic diagram illustrating an apparatus for implementing a three-dimensional panel at an IM client in accordance with a fifth embodiment of the present invention.

FIG. 7 is a schematic diagram illustrating an apparatus for implementing a three-dimensional panel at an IM client in accordance with a sixth embodiment of the present invention.

FIG. 8 is a schematic diagram illustrating an apparatus for implementing a three-dimensional panel at an IM client in accordance with a seventh embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make the object, technical scheme and merits of the present invention clearer, the present invention will be described hereinafter in detail with reference to the accompanying drawings and embodiments.

FIG. 1 is a flowchart illustrating a method for implementing a three-dimensional panel at an IM client in accordance with a first embodiment of the present invention. The method includes the following steps.

Step 101: Request information of entering a three-dimensional panel is received.

The request information is sent through an entrance of a three-dimensional panel provided by a conventional panel after an IM user logs on the conventional panel. The entrance of the three-dimensional panel may be displayed in a menu mode, a button mode or the like. Optionally, the request information may be sent after the IM user directly logs on the three-dimensional panel when the IM user logs on the IM client.

Step 102: Configuration information of the three-dimensional panel is obtained.

The configuration information is basic information of the three-dimensional panel, e.g. display angle, brightness, size, etc. Generally, IM software may configure default configuration information. In order to meet the customized demands of the user, the user is allowed to configure the configuration information. Hence, when the configuration information of the three-dimensional panel is obtained, the configuration information configured by the user is obtained first. If the configuration information configured by the user can not be obtained, the default configuration information is obtained. The configuration information is usually stored locally by the user; and preferably, the configuration information may be stored in the IM server.

Step 103: Identity information of IM contacts of the user is obtained.

Because the IM contacts need to be displayed on the three-dimensional panel of the IM software, the identity information of the IM contacts of the user needs to be obtained. The identity information is obtained from the IM software logged by the user, which is suitable for a situation that the user has already logged on a non-three-dimensional panel. Optionally, the identity information may also be obtained from the IM server, which is suitable for a situation that the user has already logged on a non three-dimensional panel as well as a situation that the user has not logged on a non three-dimensional panel.

Here, the identity information includes names, IM accounts, pictures for identifying themselves and so on used on the IM software by the IM contacts. Optionally, the identity information includes at least one of the above.

Step 104: The three-dimensional panel is started according to the configuration information, and the identity information of the IM contacts is displayed on the three-dimensional panel.

At this step, the three-dimensional panel may be started by using such a three-dimensional engine as DirectX and OpenGL.

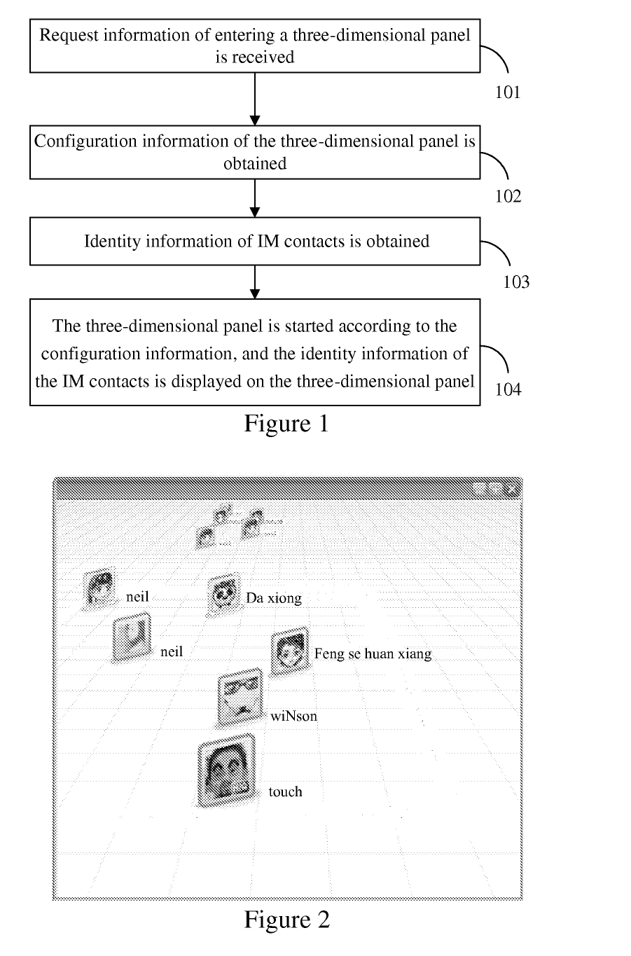

After the three-dimensional panel is started, the identity information of the IM contacts is displayed on the three-dimensional panel. For example, the identity information of the IM contacts may be displayed on the three-dimensional panel in a distributed mode, i.e. there is some space between the IM contacts, so as to be convenient for the user to search and identify the IM contacts. FIG. 2 shows one of display effects of the first embodiment of the present invention. In FIG. 2, an initialized waist-level view is given. In the three-dimensional panel shown in FIG. 2, the pictures of the IM contacts are erect and counterclockwise rotated for a certain angle. Further, in the three-dimensional panel shown in FIG. 2, the names used on the IM software by the IM contacts are also displayed.

As can be seen, according to the first embodiment of the present invention, the three-dimensional panel is implemented at the IM client, so that the IM contacts of the IM user can be displayed on the three-dimensional panel, and thus the IM user can communicate with the IM contacts in a three-dimensional scene. In this way, the problem that the conventional panel is single and short of originality is solved, and better user experiences can be brought to the IM user.

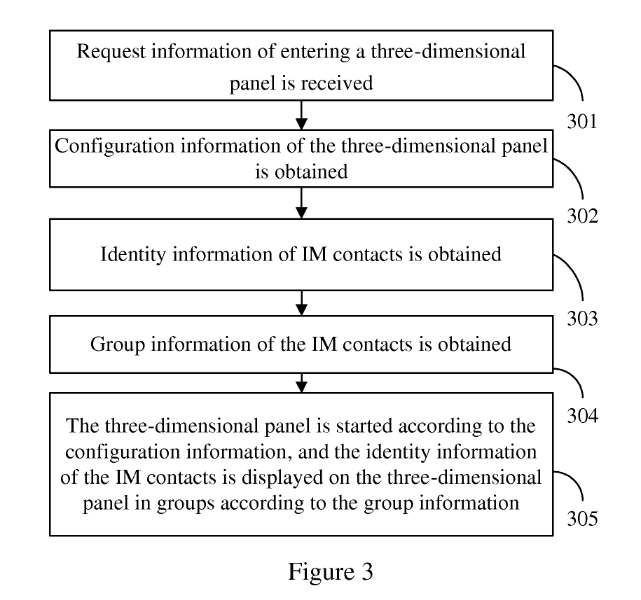

A second embodiment of the present invention further provides another method for implementing a three-dimensional panel at an IM client. FIG. 3 shows a flowchart illustrating a method for implementing a three-dimensional panel at an IM client in accordance with the second embodiment of the present invention. The method includes the following steps.

Step 301: Request information of entering a three-dimensional panel is received.

Step 302: Configuration information of the three-dimensional panel is obtained.

Step 303: Identity information of IM contacts is obtained.

Step 304: Group information of the IM contacts is obtained.

Since all IM users have a certain number of IM contacts, the IM contacts of an IM user are usually divided into groups, so as to make the IM user rapidly search the IM contacts. For example, the IM contacts may be divided into different groups, such as a student group, a colleague group, etc. Therefore, it is needed to display the IM contacts in groups when the three-dimensional panel is displayed.

Step 305: The three-dimensional panel is started according to the configuration information, and the identity information of the IM contacts is displayed on the three-dimensional panel in groups according to the group information.

After the group information of the IM contacts of the IM user is obtained, the IM contacts are displayed on the three-dimensional panel according to the groups of the IM contacts. Generally, one group of IM contacts are displayed on the three-dimensional panel at a time, so that even if the IM contacts are numerous, the IM user can quickly find an IM contact which the IM user wants to communicate with.

Preferably, a bird's-eye view may be provided on the three-dimensional panel. All user groups are displayed in the bird's-eye view, and the scene can be switched to the view shown in FIG. 2 as long as the user clicks one of the groups. At this time, if the user needs to enter another group, it is needed to return to the bird's-eye view. Preferably, a group entrance may be provided on the three-dimensional panel, and all the group information may be found at the group entrance. In this way, when the user intends to enter another group, it is just needed to click the group at the group entrance, and thus the scene can be switched to a view corresponding to the group. Here, the group entrance may be implemented in a menu mode or a button mode.

As can be seen, in the second embodiment, the group information of the IM contacts is further obtained. In this way, the identity information of one group of IM contacts is displayed on the three-dimensional panel at a time, so that the user can quickly search the IM contacts. In addition, various demands of the user can be met by displaying one group of IM contacts at a time. For example, when the user is working, only the IM contacts in a colleague group are displayed.

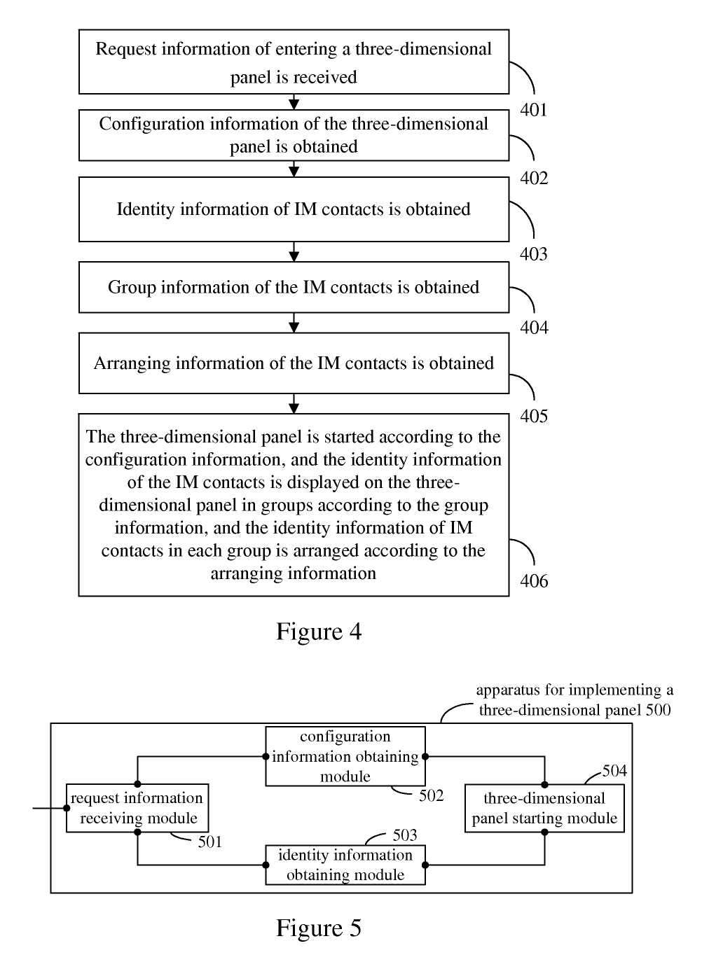

A third embodiment of the present invention provides a method for implementing a three-dimensional panel at an IM client. FIG. 4 is a flowchart illustrating the method for implementing the three-dimensional panel at the IM client in accordance with the third embodiment of the present invention. The method includes the following steps.

Step 401: Request information of entering a three-dimensional panel is received.

Step 402: Configuration information of the three-dimensional panel is obtained.

Step 403: Identity information of IM contacts is obtained.

Step 404: Group information of the IM contacts is obtained.

Step 405: Arranging information of the IM contacts is obtained.

Since the IM contacts are numerous, in order to be convenient for the user to search out a desired IM contact, the IM contacts may be arranged in a certain mode, so that the user can search out the IM contact according to a mode needed by the user. For example, the IM contacts may be arranged according to names, communication frequencies, lengths of communication time and the like. Preferably, areas in which the IM contacts are located may be obtained according the IP addresses of the IM contacts, and then the IM contacts may be arranged according to the distance between the areas of the IM contacts and the area in which the user is located. Preferably, the user may define the arranging mode of the IM contacts himself. In addition, the three-dimensional panel may display only on-line IM contacts or all the IM contacts in the corresponding group.

Step 406: The three-dimensional panel is started according to the configuration information, the identity information of the IM contacts is displayed on the three-dimensional panel according to the groups corresponding to the group information, and the identity information of IM contacts in each group is arranged according to the arranging information.

As can be seen, in the third embodiment, the arranging information of the IM contacts is further obtained, so that the IM contacts can be arranged on the three-dimensional panel according to the obtained arranging information. Therefore, the user can quickly find a desired IM contact according to the arrangement of the IM contacts.

In the second and third embodiments of the present invention, the implementing process of the three-dimensional panel is described in detail. For facilitating the user to communicate with the IM contacts, after the three-dimensional panel is started, the following steps are included: operation information of changing the display of the three-dimensional panel is received; and the identity information of the IM contacts is displayed on the three-dimensional panel according to an operation requested by the operation information.

Preferably, the operation information is to request to communicate with a certain user. Here, the communication with the IM contacts may include at least one of text communication, audio communication and video communication. In addition, the operation information may be to request to change the display content of the three-dimensional panel, such as an operation of translating a certain user.

If the operation requested by the operation information is to communicate with a certain IM contact, a communication interface is opened, so that the user can communicate with the IM contact. The communication interface may be added to the original three-dimensional panel or may be a new window interface. When the communication object is a single IM contact, the identity information of the IM contact is displayed on the interface. When the communication object is a group including multiple single IM contacts, only one communication window is displayed when the communication is performed, but the identity information of all the IM contacts participating in the communication is displayed on the interface. Further, the user may send a picture expressing a mood or wish to the communication object through the communication window. The picture preferably may be stored by the IM client or added by the user.

When the user clicks a blank area or an IM contact on the three-dimensional panel, the vision focus of a three-dimensional scene displayed on the three-dimensional panel may be translated to the blank area or the IM contact clicked by the user. In practical applications, a gradually effect may be added to the translation, i.e. make the angle of view move continuously to bring a new experience to the user.

Preferably, in order to further increase the user experiences of the user, the user may customize the arranging information of the IM contacts, the configuration information of the three-dimensional panel and so on, a control panel may be further displayed on the three-dimensional panel, and the user may configure the arranging information of the IM contacts and the configuration information of the three-dimensional panel on the control panel. If control information on the control panel is changed, the three-dimensional panel is restarted according to the changed control information. In this way, the user can change the control information through the control panel to make the three-dimensional panel be displayed according to the demands of the user, thereby meeting the customized demands of the user and increasing the user experiences.

The above is a detailed description of the method for implementing the three-dimensional panel at the IM client provided by the embodiments of the present invention. It should be understood that, in the above embodiments, after the request information is received, the sequence of performing the steps of obtaining the configuration information, obtaining the identity information, obtaining the group information and obtaining the arranging information is not fixed and may be arranged arbitrarily. Therefore, in the embodiments of the present invention, the sequence of performing the steps of obtaining the configuration information, obtaining the identity information, obtaining the group information and obtaining the arranging information is not limited.

A fourth embodiment of present invention provides an apparatus for implementing a three-dimensional panel. FIG. 5 is a flowchart illustrating an apparatus for implementing a three-dimensional panel at an IM client in accordance with the fourth embodiment of the present invention. The apparatus for implementing a three-dimensional panel 500 includes the following module.

A request information receiving module 501, adapted to receive request information of entering a three-dimensional panel.

A configuration information obtaining module 502, adapted to obtaining configuration information of the three-dimensional panel after the request information receiving module receives the request information.

An identity information obtaining module 503, adapted to obtain identity information of IM contacts after the request information receiving module receives the request information.

A three-dimensional panel starting module 504, adapted to start the three-dimensional panel according to the configuration information and display the identity information of the IM contacts on the three-dimensional panel.

As can be seen from the fourth embodiment of the present invention, the three-dimensional panel can be implemented at the IM client, so that the IM contacts of the IM user can be displayed on the three-dimensional panel, and thus the IM user can communicate with the IM contacts in a three-dimensional scene, thereby solving the problem that the conventional panel is single and short of originality, and bringing better user experiences for the IM user.

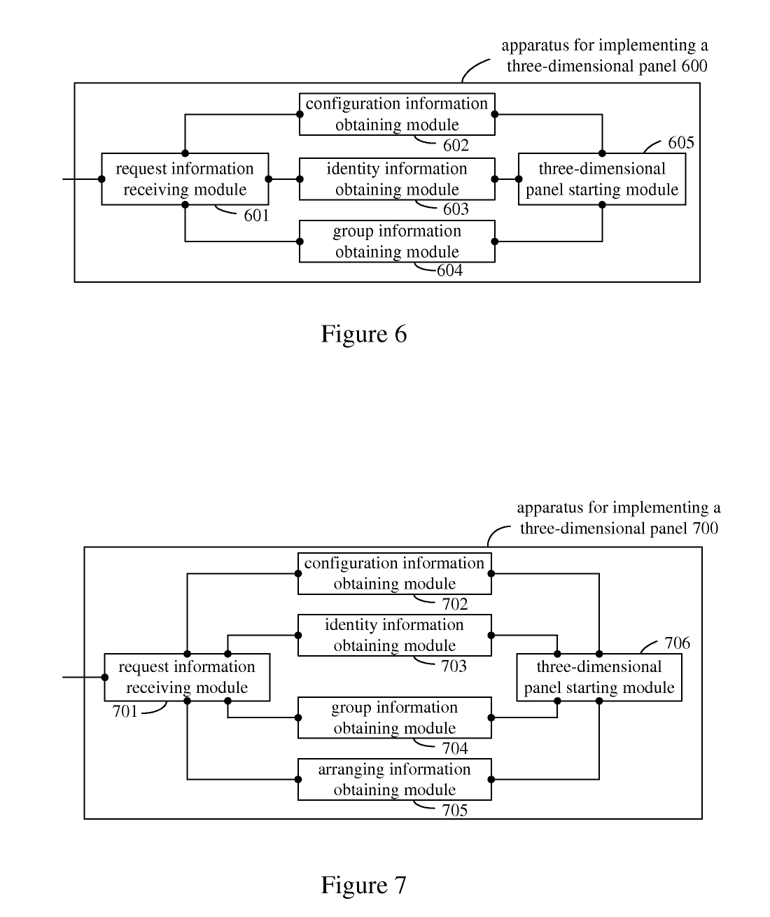

A fifth embodiment of present invention further provides another apparatus for implementing a three-dimensional panel. FIG. 6 is a flowchart illustrating an apparatus for implementing a three-dimensional panel at an IM client in accordance with the fifth embodiment of the present invention. The apparatus for implementing a three-dimensional panel 600 shown in FIG. 6 includes the following module.

A request information receiving module 601, adapted to receive request information of entering a three-dimensional panel.

A configuration information obtaining module 602, adapted to obtaining configuration information of the three-dimensional panel after the request information receiving module receives the request information.

An identity information obtaining module 603, adapted to obtain identity information of IM contacts after the request information receiving module receives the request information.

A group information obtaining module 604, adapted to obtain group information of the IM contacts after the request information receiving module receives the request information.

A three-dimensional panel starting module 605, adapted to display the identity information of the IM contacts on the three-dimensional panel in groups according to the group information.

As can be seen, in the fifth embodiment, the group information of the IM contacts is further obtained. In this way, the identity information of one group of IM contacts is displayed on the three-dimensional panel at a time, so that the user can quickly search the IM contacts. In addition, various demands of the IM user can be met by displaying one group of IM contacts at a time. For example, when the user is working, only the IM contacts in a colleague group are displayed.

A sixth embodiment of present invention further provides anther apparatus for implementing a three-dimensional panel. FIG. 7 is a schematic diagram illustrating an apparatus for implementing a three-dimensional panel at an IM client in accordance with the sixth embodiment of the present invention. The apparatus for implementing a three-dimensional panel 700 shown in FIG. 7 includes the following module.

A request information receiving module 701, adapted to receive request information of entering a three-dimensional panel.

A configuration information obtaining module 702, adapted to obtaining configuration information of the three-dimensional panel after the request information receiving module receives the request information.

An identity information obtaining module 703, adapted to obtain identity information of IM contacts after the request information receiving module receives the request information.

A group information obtaining module 704, adapted to obtain group information of the IM contacts after the request information receiving module receives the request information.

An arranging information obtaining module 705, adapted to obtain arranging information of the IM contacts after the request information receiving module receives the request information.

A three-dimensional panel starting module 706, adapted to start the three-dimensional panel according to the configuration information and display the identity information of the IM contacts on the three-dimensional panel in groups according to the group information, and the identity information of IM contacts in each group is arranged according to the arranging information of the IM contacts.

As can be seen, in the sixth embodiment, the arranging information of the IM contacts is further obtained, so that the IM contacts can be arranged on the three-dimensional panel according to the obtained arranging information. Therefore, the user can quickly find a desired IM contact according to the arrangement of the IM contacts.

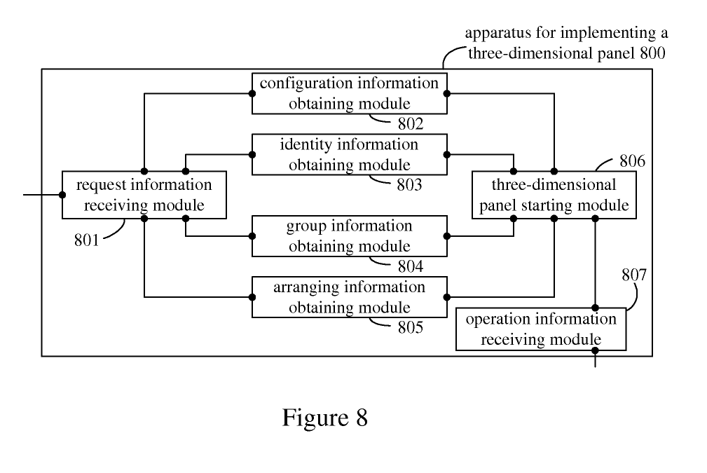

A seventh embodiment of present invention further provides another apparatus for implementing a three-dimensional panel. FIG. 8 is a schematic diagram illustrating an apparatus for implementing a three-dimensional panel at an IM client in accordance with the seventh embodiment of the present invention. As shown in FIG. 8, the apparatus for implementing a three-dimensional panel includes the following module.

A request information receiving module 801, adapted to receive request information of entering a three-dimensional panel.

A configuration information obtaining module 802, adapted to obtaining configuration information of the three-dimensional panel after the request information receiving module receives the request information.

An identity information obtaining module 803, adapted to obtain identity information of IM contacts after the request information receiving module receives the request information.

A group information obtaining module 804, adapted to obtain group information of the IM contacts after the request information receiving module receives the request information.

An arranging information obtaining module 805, adapted to obtain arranging information of the IM contacts after the request information receiving module receives the request information.

A three-dimensional panel starting module 806, adapted to start the three-dimensional panel according to the configuration information and display the identity information of the IM contacts on the three-dimensional panel in groups according to the group information, and the identity information of IM contacts in each group is arranged according to the arranging information of the IM contacts.

An operation information receiving module 807, adapted to receive operation information of changing the display of the three-dimensional panel.

The three-dimensional panel starting module 806 is further adapted to display the identity information of the IM contacts on the three-dimensional panel according to an operation requested by the operation information.

In this embodiment, when the operation requested by the operation information is performed, a process of gradually changing is presented according to the three-dimensional demands in the case that the angle of view is kept unchanged, thereby increasing the experiences of the user.

Preferably, in order to further meet the customized demands of the user, the three-dimensional panel starting module is further adapted to display a control panel on the three-dimensional panel. When the control information on the control panel is changed, the three-dimensional panel starting module is further adapted to restart the three-dimensional panel according to the changed control information. In this way, the user can change the control information through the control panel to make the three-dimensional panel be displayed according to the demands of the user, thereby meeting the customized demands of the user and increasing the user experiences.

In addition, an eighth embodiment of the present invention provides a computer program product for implementing a three-dimensional panel at an IM software client. The computer program product includes a computer program code. When the computer program code is run on a computer device, one or more steps of the methods provided by the embodiments of the present invention are implemented, so as to implement one or more modules in the system or apparatus of the present invention. For example, when the computer program code is run on the computer device, one or more components or functions of the one or more of the request information receiving module, the configuration information obtaining module, the identity information obtaining module and the three-dimensional panel starting module may be implemented.

The above computer program product may be stored in a computer readable medium, such as a read only memory (ROM), a random access memory (RAM) and a flash. It should be understood that the computer program code can also be downloaded to the computer device from a data network, and the downloaded computer program code may replace or update the computer program code that already exists.

The foregoing are only preferred embodiments of the present invention and are not for use in limiting the protection scope of the present invention. Any modification, equivalent replacement and improvement made within the scope of the present invention should be covered under the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for implementing a three-dimensional panel at an Instant Messaging, IM, client, comprising:
receiving request information of entering a three-dimensional panel;
obtaining configuration information of the three-dimensional panel;
obtaining identity information of IM contacts; and
starting the three-dimensional panel according to the configuration information and displaying the identity information of the IM contacts on the three-dimensional panel.

2. The method of claim 1, after receiving the request information of entering the three-dimensional panel, further comprising:
obtaining group information of the IM contacts; and
displaying the identity information of the IM contacts on the three-dimensional panel in groups according to the group information.

3. The method of claim 2, further comprising:
providing on the three-dimensional panel a group entrance displaying each piece of group information.

4. The method of claim 1, after receiving the request information of entering the three-dimensional panel further comprising:
obtaining arranging information of the IM contacts; and
displaying the identity information of the IM contacts on the three-dimensional panel according to the arranging information.

5. The method of claim 4, wherein the arranging information comprises:
names, communication frequencies, lengths of communication time or IP addresses of the IM contacts.

6. The method of claim 1, after displaying the identity information of the IM contacts on the three-dimensional panel, further comprising:
receiving operation information of changing the display of the three-dimensional panel; and
displaying the identity information of the IM contacts on the three-dimensional panel according an operation requested by the operation information.

7. The method of claim 2, after displaying the identity information of the IM contacts on the three-dimensional panel, further comprising:
receiving operation information of changing the display of the three-dimensional panel; and
displaying the identity information of the IM contacts on the three-dimensional panel according an operation requested by the operation information.

8. The method of claim 4, after displaying the identity information of the IM contacts on the three-dimensional panel, further comprising:
receiving operation information of changing the display of the three-dimensional panel; and
displaying the identity information of the IM contacts on the three-dimensional panel according an operation requested by the operation information.

9. The method of claim 1, further comprising:
displaying a control panel on the three-dimensional panel; and
restarting the three-dimensional panel according to changed control information when the control information on the control panel is changed.

10. The method of claim 1, wherein the identity information comprises at least one of names, IM accounts and pictures used by the IM contacts.

11. The method of claim 1, wherein the three-dimensional panel is started through a DirectX or OpenGL three-dimensional engine.

12. The method of claim 1, wherein the identity information is obtained from an IM software when the IM software is logged on or obtained from an IM server.

13. The method of claim 1, wherein the request information of entering the three-dimensional panel is sent through a three-dimensional panel entrance with a menu mode or a button mode after an IM software is logged on; or
the request information of entering the three-dimensional panel is sent when the IM software is logged on.

14. An apparatus for implementing a three-dimensional panel at an Instant Messaging, IM, client, comprising:
a request information receiving module, adapted to receive request information of entering a three-dimensional panel;
a configuration information obtaining module, adapted to obtain configuration information of the three-dimensional panel after the request information receiving module receives the request information;
an identity information obtaining module, adapted to obtain identity information of IM contacts after the request information receiving module receives the request information; and
a three-dimensional panel starting module, adapted to start the three-dimensional panel according to the configuration information and display the identity information of the IM contacts on the three-dimensional panel.

15. The apparatus of claim 14, further comprising:
a group information obtaining module, adapted to obtain group information of the IM contacts after the request information receiving module receives the request information; wherein
the three-dimensional panel starting module is further adapted to display the identity information of the IM contacts on the three-dimensional panel in groups according to the group information.

16. The apparatus of claim 14, further comprising:
an arranging information obtaining module, adapted to obtain arranging information of the IM contacts after the request information receiving module receives the request information; wherein
the three-dimensional panel starting module is further adapted to display the identity information of the IM contacts on the three-dimensional panel according to the arranging information.

17. The apparatus of claim 14, further comprising:
an operation information receiving module, adapted to receive operation information of changing the display of the three-dimensional panel; wherein
the three-dimensional panel starting module is further adapted to display the identity information of the IM contacts on the three-dimensional panel according an operation requested by the operation information.

18. The apparatus of claim 16, further comprising:
an operation information receiving module, adapted to receive operation information of changing the display of the three-dimensional panel; wherein
the three-dimensional panel starting module is further adapted to display the identity information of the IM contacts on the three-dimensional panel according an operation requested by the operation information.

19. The apparatus of claim 14, wherein the three-dimensional panel starting module is further adapted to display a control panel on the three-dimensional panel, and restart the three-dimensional panel according to changed control information when the control information on the control panel is changed.

20. A computer program product for implementing a three-dimensional panel at an Instant Messaging, IM, software client, comprising:
a computer program code, adapted to execute the steps in the method claimed in claim 1 when being run.

21. A computer readable medium, comprising the computer program product claimed in claim 20.
